(19) United States
(12) Patent Application Publication
(10) Pub. No.: US 2020/0370439 A1
(43) Pub. Date: Nov. 26, 2020

(54) TEXTURED SUBSURFACE COATING SEGMENTATION

(71) Applicants: Rolls-Royce Corporation, Indianapolis, IN (US); Rolls-Royce North American Technologies, Inc., Indianapolis, IN (US)

(72) Inventors: Scott Nelson, Carmel, IN (US); Gregory John Kenneth Harrington, Indianapolis, IN (US); Matthew R. Gold, Carmel, IN (US); Li Li, Carmel, IN (US)

(21) Appl. No.: 16/879,800

(22) Filed: May 21, 2020

Related U.S. Application Data
(60) Provisional application No. 62/852,168, filed on May 23, 2019.

(51) Int. Cl. F01D 5/28; B05D 5/02; B05D 3/12; B23P 6/00; B23K 26/36

(52) U.S. Cl. CPC F01D 5/284; B05D 5/02; B05D 3/12; B23K 26/36; F01D 5/288; B23P 6/007; F01D 5/286

(57) ABSTRACT

The disclosure describes an article and a method of making the same that includes a substrate defining an outer surface, a bond coat on the outer surface of the substrate, the bond coat defining a textured surface having a plurality of cells, each cell having a geometry and a depth, where the depth of a respective cell is different than the depth of at least one adjacent cell, and a coating formed on the textured surface of the bond coat.

This application claims the benefit of U.S. Provisional Application Ser. No. 62/852,168, entitled “TEXTURED SUBSURFACE COATING SEGMENTATION,” filed on May 23, 2019, the entire content of which is incorporated herein by reference.

### TECHNICAL FIELD

The present disclosure relates to coating interfaces, and more particularly, but not exclusively, to coating interfaces on composite substrates.

### BACKGROUND

Ceramic matrix composite (CMC) materials may be useful in a variety of contexts where mechanical and thermal properties are important. For example, components of high temperature mechanical systems, such as gas turbine engines, may be made from CMCs. CMCs may be resistant to high temperatures, but some CMCs may react with some elements and compounds present in the operating environment of high temperature mechanical systems, such as water vapor. These reactions may damage the CMC and reduce mechanical properties of the CMC, which may reduce the useful lifetime of the component. Thus, in some examples, a CMC component may be coated with various coatings, which may reduce exposure of the CMC component to elements and compounds present in the operating environment of high temperature mechanical systems.

### SUMMARY

The disclosure describes articles and techniques for reducing propagation of, or cracks due to, crystallization of thermally grown oxide (TGO) in a coating system of a composite article. TGO may form on a surface of a metal-containing bond coat or an interface between a metal-containing bond coat and an overlying layer. For example, TGO and the cracking that results from crystallization of TGO may occur between a bond coat on a substrate and a coating on the bond coat. The disclosed articles and techniques may segment the TGO by texturing the bond coat. In some examples, the texturing may include a plurality of cells in the bond coat, each cell having a geometry in a plane of the bond coat and depth relative to a plane defined by the substrate. The geometry of each cell may include any suitable geometry. The depth of adjacent cells may be different. The variation in depth of adjacent cells may reduce propagation of TGO or cracking between adjacent cells.

In some examples, the disclosure describes an article including a substrate defining an outer surface, a bond coat formed on the outer surface of the substrate and defining a textured surface having a plurality of cells, each cell having a geometry and a depth, where the depth of a respective cell is different than the depth of each adjacent cell, and a coating formed on the textured surface of the bond coat.

In some examples, the disclosure describes a method for forming an article, the method includes forming a bond coat on an outer surface of a substrate, texturing the bond coat by forming a plurality of cells in the bond coat, each cell having a geometry and a depth, where the depth of a respective cell is different than the depth of each adjacent cell, and forming a coating on the textured surface of the bond coat.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a conceptual cross-sectional view of an example article including a substrate, a bond coat having a textured surface, and a coating on the bond coat.

FIG. 2 is a schematic diagram illustrating an article including a bond coat having a textured surface including a plurality of cells formed by directing an ablating laser at the bond coat.

FIGS. 3A-3G are conceptual top-views of an example plurality of cells arranged in a variety of patterns in a bond coat.

FIG. 4 is a flow diagram illustrating an example technique for forming an article that includes a bond coat having a textured surface, and a coating on the bond coat.

### DETAILED DESCRIPTION

In general, the disclosure describes articles and techniques for forming articles that include a bond coat having a textured surface and a coating on the textured surface of the bond coat. An example article may include a component of a high temperature mechanical system, such as a gas turbine engine airfoil or vane. The component may include a substrate, such as a composite substrate, and a coating system that includes the bond coating having the textured surface and the coating on the bond coat. In some examples, the coating on the bond coat includes an environmental barrier coating (EBC), a thermal barrier coating (TBC), or both.

The textured surface of the bond coat may define a plurality of cells. Each cell of the plurality of cells may define a geometry in a plane of the bond coat and a depth relative to a plane tangential to the outer surface of the substrate. The geometry of each respective cell may include, for example, a hexagon, a cross, a triangle, a chevron, a circle, an irregular shape, or a geometry based on stress modeling of the component. In some examples, the geometries of the plurality of cells may define a repeating pattern. The depth of each respective cell may be different than the depth of at least one adjacent cell of the plurality of cells.

Because adjacent cells of the plurality of cells are at different depths, the article may reduce propagation of crystallization of thermally grown oxide (TGO) or cracks due to crystallization of the TGO. For example, TGO and the cracking that results from crystallization of TGO may occur between the bond coat and the coating. The plurality of cells may segment the TGO to reduce propagation of TGO or cracking between adjacent cells of the plurality of cells. In this way, failure across a single plane of the coating may be reduced and TGO may form in adjacent cells with varying thicknesses which may result in non-uniform residual stress within the coating system (bond coat and coating on the bond coat) and thereby reduce complete failure of the coating system. By reducing failure across a single plane of the coating system and reducing complete failure of the coating system, the described articles and technique may increase the useable life of the component.

In some examples, the plurality of cells may be formed in the bond coat using laser ablation. The laser ablation process may reduce the chance of the bond coat or the substrate cracking during processing (e.g., compared to using mechanical machining). Laser ablation may also result in a cleaner outer surface compared to other processing techniques (e.g., micromachining or grit blasting), which may also improve the adhesion between the bond coat and the coating. For example, the cleaner outer surface may include few impurities or defects, such as oxides, nitrides, or residues that may be caused by other processing techniques. Additionally, or alternatively, the laser ablation process may reduce the amount of heat applied to the outer surface of the bond coat and/or the substrate compared to mechanical machining, thereby reducing the likelihood of the underlying reinforcement material of the substrate becoming oxidized and having its mechanical properties compromised. The laser ablation process also may have the benefit of being highly localized and may be applied in specific locations as needed and not in sensitive areas, which may reduce material degradation.

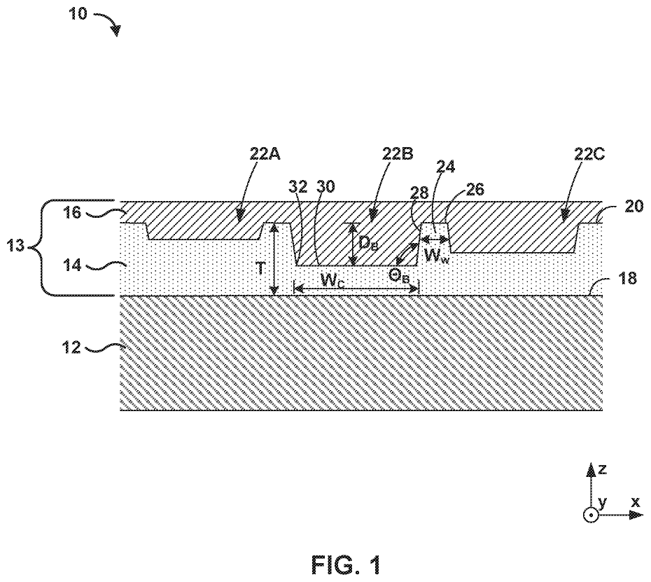

FIG. 1 is a conceptual cross-sectional view of an example article 10 including a substrate 12 and a coating system 13. Coating system 13 may include a bond coat 14 and a coating 16 on bond coat 14. In some examples, coating system 13 may include additional coating layers (e.g., coating 16 may include a plurality of layers). Substrate 12 defines an outer surface 18 extending in the x-y plane of FIG. 1. Bond coat 14 is on outer surface 18. Bond coat 14 defines textured surface 20. Textured surface 20 includes a plurality of cells 22A, 22B, and 22C (collectively, “cells 22”). Each cell of cells 22 defines a geometry, e.g., in the x-y plane (a major plane of bond coat 14), and a depth, e.g., extending in the z-direction of FIG. 1 (substantially normal to outer surface 18). The depth of a respective cell of cells 22 may be different than the depth of at least one adjacent cell of cells 22 (e.g., each adjacent cell of cells 22). For example, cell 22B has a depth D_{B}, which is greater than a depth of adjacent cells 22A and 22C. Because cells 22 have different depths, cells 22 are configured to segment bond coat 14 and any TGO on bond coat 14 to reduce propagation of TGO or cracking between adjacent cells of the plurality of cells 22.

In some examples, textured surface 20 of bond coat 14 may define a plurality of walls separating adjacent cells, e.g., wall 24 separating cell 22B and 22C. Wall 24 includes an apex 26 and defines cell wall 28. In some examples, adjacent cells of cells 22 may be separated by a selected distance (e.g., the width of wall 24). For example, a width W_{W} of wall 24 may be within a range from about 10 microns to about 100 microns, such as from about 20 microns to about 60 microns. In some examples, textured surface 20 may not include cell walls 24, such that each cell of cells 22 is defined by the difference in depth of adjacent cells.

Cell wall 28 extends from cell base 30 to apex 26. Apex 26 may include a plateau that is substantially parallel to outer surface 18 of substrate 12 (e.g., as illustrated in FIG. 1) or any suitable rectilinear surface, curvilinear surface, or point. Cell wall 28 may extend from cell base 30 at any suitable angle. In some examples, cell wall 28 may define a right angle, such as, for example, an angle that is about 90-degrees relative to a plane defined by outer surface 18 of substrate 20 (e.g., relative to the x-y plane of FIG. 1). Using a right angle may facilitate manufacturing by enabling cells 22 to be formed while only requiring a material removal device to be kept perpendicular to the surface of article 10. In some examples, cell wall 28 may define an obtuse angle, such as, for example, an angle within a range from about 90-degrees to about 110-degrees. An obtuse angle may facilitate application of coating 16 by, for example, thermal spraying, because edges and/or corners of a respective cell, e.g., edge 32 of cell 22B, are not shadowed from the spray head. In some examples, cell wall 28 may define an acute angle, such as, for example, an angle within a range from about 70-degrees to about 90-degrees. An acute angle may enhance bonding of coating 16 to textured surface 20 because undercuts defined by cell wall 28 define a mechanical interlock of coating 16 and underlying bond coat 14.

Bond coat 14 defines a thickness T. For example, thickness T may include a distance from outer surface 18 of substrate 12 to apex 26 of wall 24 defined by bond coat 14. In some examples, thickness T may be within a range from about 5 microns to about 500 microns, such as about 25 microns to about 250 microns, or about 75 microns to about 385 microns, or about 75 microns to about 255 microns. In some examples, each cell of cells 22 may define depth between about 25% to about 100% of the thickness T of bond coat 14. Selecting the thickness of adjacent cells of cells 22 may enable coating 16 to provide selected chemical and/or mechanical properties and a selected difference between depths of adjacent cells of cells 22 to reduce propagation of TGO among adjacent cells 22 and cracking resulting from TGO crystallization.

The geometry of each cell of cells 22 may be substantially similar or cells 22 may include two or more dissimilar geometries. The shape and size of each cell of cells 22 may be selected to reduce propagation of TGO and cracking resulting from TGO crystallization. In some examples, the geometry of each cell of cells 22 may include at least one of a polygon, a triangle, a parallelogram, a hexagon, a cross, a chevron, a circle, or other geometric shapes. In some examples, the geometry of each cell of cells 22 may define irregular shapes or shapes based on a geometry of article 10. For example, in examples in which article 10 includes a gas turbine engine blade, cells 22 at a leading edge of the blade may include a first geometry and cells 22 at a trailing edge of the blade may include a second geometry. In some examples, the geometry of each respective cell of cells 22 may include a width of the respective cell. For example, a width of the widest portion of a respective cell of cells 22 (e.g., the width) may be within a range between about 20 microns and about 300 microns, such as between about 120 microns and about 200 microns.

Article 10 may include any applicable structure that may benefit from the reduced propagation of TGO or cracking due to TGO crystallization, such as cracks extending between layers of coating system 13 on article 10. In some examples, article 10 may be a component of a high temperature mechanical system. For example, article 10 may be a gas turbine engine component configured to operate in high temperature environments, e.g., operating at temperatures of 1900° to 2100° F. or greater. In some examples, article 10 may be a component of a gas turbine engine that is exposed to hot gases, including, for example, a seal segment, a blade track, an airfoil, a blade, a vane, a combustion chamber liner, or the like.

In examples in which article 10 includes a component of a high temperature mechanical system, the geometry of a respective cell of cells 22 may be based on a predicted stress at the respective cell during operation of the high temperature mechanical system. For example, a first portion of the component of the high temperature mechanical system may experience a greater thermal and/or mechanical stress during operation of the mechanical system relative to a second portion of the component. As one example, a leading edge of a gas turbine engine blade may experience greater thermal and mechanical stress during operation of a gas turbine engine compared to a trailing edge of the gas turbine engine blade. The first portion of the component may include a first plurality of cells having a first geometry, and the second portion of the component may include a second plurality of cells having a second geometry. In this way, the geometry of the plurality of cells may be selected to withstand selected thermal and/or mechanical stresses.

Substrate 12 of article 10 may be formed from various materials including, for example, a superalloy, a fiber reinforced composite, a ceramic matrix composite (CMC), a metal matrix composite, a hybrid material, combinations thereof, or the like. In some examples, substrate 12 may be a ceramic or CMC substrate. The ceramic or CMC material may include, for example, a silicon-containing ceramic, such as silica (SiO₂), silicon carbide (SiC), silicon nitride (SiN₄), alumina (Al₂O₃), aluminosilicate, or the like. In some examples, the ceramic may be substantially homogeneous and may include substantially a single phase of material. In other examples, substrate 12 may include a matrix material and reinforcement material. Suitable matrix materials may include, for example, carbon, silicon carbide (SiC), silicon carbide aluminum boron silicide, silicon nitride (Si₃N₄), alumina (Al₂O₃), aluminosilicate, silica (SiO₂), or the like. In some examples, the matrix material of the CMC substrate may include carbon, boron carbide, boron nitride, or resin (epoxy/polyimide). The matrix material may be combined with any suitable reinforcement materials including, for example, discontinuous whiskers, platelets, or particulates composed of SiC, Si₃N₄, Al₂O₃, aluminosilicate, SiO₂, or the like. In some examples the reinforcement material may include continuous monofilament or multifilament fibers that include fibers of SiC. The reinforcement fibers may be woven or non-woven. In other examples, substrate 12 may include a metal alloy that includes silicon, such as a molybdenum-silicon alloy (e.g., MoSi₂) or a niobium-silicon alloy (e.g., NbSi₂).

Substrate 12 may be produced using any suitable means. For example, substrate 12 may be produced from a porous preform including reinforcement fibers. The porous preformed may be impregnated with a matrix material using e.g., resin transfer molding (RTM), chemical vapor infiltration (CVI), chemical vapor deposition (CVD), slurry infiltration, melt infiltration, or the like and/or heat treated to produce substrate 12.

Bond coat 14 may include any useful material to improve adhesion between substrate 12 and coating 16. For example, bond coat 14 may be formulated to exhibit desired chemical or physical attraction between substrate 12 and coating 16. In some examples, bond coat 14 may include silicon metal, alone, or mixed with at least one other constituent. The at least one other constituent may include, for example, at least one of a transition metal carbide, a transition metal boride, or a transition metal nitride. Representative transition metals include, for example, Cr, Mo, Nb, W, Ti, Ta, Hf, or Zr. In some examples, bond coat 14 may additionally or alternatively include mullite (aluminum silicate, Al₆Si₂O₁₃), silica, a silicide, or the like, alone, or in any combination (including in combination with one or more of silicon metal, a transition metal carbide, a transition metal boride, or a transition metal nitride). In some examples, bond coat 14 may be applied by techniques such as spraying (e.g., thermal or plasma spray), pressure vapor deposition (PVD), chemical vapor deposition (CVD), directed vapor deposition (DVD), dipping, electroplating, chemical vapor infiltration (CVI), or the like.

Coating 16 may include one or more of a thermal barrier coating (TBC), an environmental barrier coating (EBC), an abradable coating, a calcia-magnesia-aluminosilicate (CMAS)-resistant coating, combinations thereof, or the like. In some examples, coating 16 may perform two or more of functions (e.g., act as an EBC and abradable layer). Coating 16 may be applied to at least partially fill cells 22. In some examples, coating 16 may be applied by techniques such as spraying (e.g., thermal or plasma spray), pressure vapor deposition (PVD), chemical vapor deposition (CVD), directed vapor deposition (DVD), dipping, electroplating, chemical vapor infiltration (CVI), or the like. In some examples, the composition of coating 16 may be selected based on coefficients of thermal expansion, chemical compatibility, thickness, operating temperatures, oxidation resistance, emissivity, reflectivity, and longevity. Coating 16 may be applied on selected portions and only partially cover substrate 12 and/or bond coat 14, or may cover substantially all of substrate 12 and/or bond coat 14.

In examples in which coating 16 includes an EBC, the EBC may include materials that are resistant to oxidation or water vapor attack, and/or provide at least one of water vapor stability, chemical stability and environmental durability to substrate 12. In some examples, the EBC may be used to protect substrate 12 against oxidation and/or corrosive attacks at high operating temperatures. For example, EBCs may be applied to protect the ceramic composites such as SiC based CMCs. An EBC coating may include at least one of a rare earth oxide, a rare earth silicate, an aluminosilicate, or an alkaline earth aluminosilicate. For example, an EBC coating may include mullite, barium strontium aluminosilicate (BSAS), barium aluminosilicate (BAS), strontium aluminosilicate (SAS), at least one rare earth oxide, at least one rare earth monosilicate (RE₂SiO₅, where RE is a rare earth element), at least one rare earth disilicate (RE₂Si₂O₇, where RE is a rare earth element), or combinations thereof. The rare earth element in the at least one rare earth oxide, the at least one rare earth monosilicate, or the at least one rare earth disilicate may include at least one of Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium). In some examples, the at least one rare earth oxide includes an oxide of at least one of Yb, Y, Gd, or Er.

In some examples, an EBC coating may include at least one rare earth oxide and alumina, at least one rare earth oxide and silica, or at least one rare earth oxide, silica, and alumina. In some examples, an EBC coating may include an additive in addition to the primary constituents of the EBC coating. For example, an EBC coating may include at least one of TiO₂, Ta₂O₅, HfSiO₄, an alkali metal oxide, or an alkali earth metal oxide. The additive may be added to the EBC coating to modify one or more desired properties of the EBC coating. For example, the additive components may increase or decrease the reaction rate of the EBC coating with CMAS, may modify the viscosity of the reaction product from the reaction of CMAS and the EBC coating, may increase adhesion of the EBC coating to substrate 12, may increase or decrease the chemical stability of the EBC coating, or the like.

In some examples, the EBC coating may be substantially free (e.g., free or nearly free) of hafnia and/or zirconia. Zirconia and hafnia may be susceptible to chemical attack by CMAS, so an EBC coating substantially free of hafnia and/or zirconia may be more resistant to CMAS attack than an EBC coating that includes zirconia and/or hafnia.

In some examples, the EBC coating may have a dense microstructure, a columnar microstructure, or a combination of dense and columnar microstructures. A dense microstructure may be more effective in preventing the infiltration of CMAS and other environmental contaminants, while a columnar microstructure may be more strain tolerant during thermal cycling. A combination of dense and columnar microstructures may be more effective in preventing the infiltration of CMAS or other environmental contaminants than a fully columnar microstructure while being more strain tolerant during thermal cycling than a fully dense microstructure. In some examples, an EBC coating with a dense microstructure may have a porosity of less than about 20 volume percent (vol. %), such as less than about 15 vol. %, less than 10 vol. %, or less than about 5 vol. %, where porosity is measured as a percentage of pore volume divided by total volume of the EBC coating.

In some examples, coating 16 may include a thermal barrier coating (TBC). The TBC may include at least one of a variety of materials having a relatively low thermal conductivity and may be formed as a porous or a columnar structure in order to further reduce thermal conductivity of the TBC and provide thermal insulation to substrate 12. In some examples, the TBC may include materials such as ceramic, metal, glass, pre-ceramic polymer, or the like. In some examples, the TBC may include silicon carbide, silicon nitride, boron carbide, aluminum oxide, cordierite, molybdenum disilicide, titanium carbide, stabilized zirconia, stabilized hafnia, or the like.

In some examples, coating 16 may include an abradable layer. The abradable layer may include any of the EBC or TBC compositions described herein. The abradable layer may be porous. Porosity of the abradable layer may reduce a thermal conductivity of the abradable layer and/or may affect the abradability of the abradable layer. In some examples, the abradable layer includes porosity between about 10 vol. % and about 50 vol. %. In other examples, the abradable layer includes porosity between about 15 vol. % and about 35 vol. %, or about 20 vol. %. Porosity of the abradable layer is defined herein as a volume of pores or voids in the abradable layer divided by a total volume of the abradable layer, including both the volume of material in the abradable layer and the volume of pores or voids in the abradable layer.

The abradable layer may be formed using, for example, a thermal spraying technique, such as, for example, plasma spraying. Porosity of the abradable layer may be controlled by the use of coating material additives and/or processing techniques to create the desired porosity. In some examples, substantially closed pores may be desired. For example, a coating material additive that melts or burns at the use temperatures of the component (e.g., a blade track) may be incorporated into the coating material that forms the abradable layer. The coating material additive may include, for example, graphite, hexagonal boron nitride, or a polymer such as a polyester, and may be incorporated into the coating material prior to deposition of the coating material over textured surface 20 to form the abradable layer. The coating material additive then may be melted or burned off in a subsequent heat treatment, or during operation of the gas turbine engine, to form pores in the abradable layer. The post-deposition heat-treatment may be performed at up to about 1500° C.

The porosity of the abradable layer can also be created and/or controlled by plasma spraying the coating material using a co-spray process technique in which the coating material and coating material additive are fed into the plasma stream with two radial powder feed injection ports. The feed pressures and flow rates of the coating material and coating material additive may be adjusted to inject the material on the outer edge of the plasma plume using direct 90-degree angle injection. This may permit the coating material particles to soften but not completely melt and the coating material additive to not burn off but rather soften sufficiently for adherence in the abradable layer.

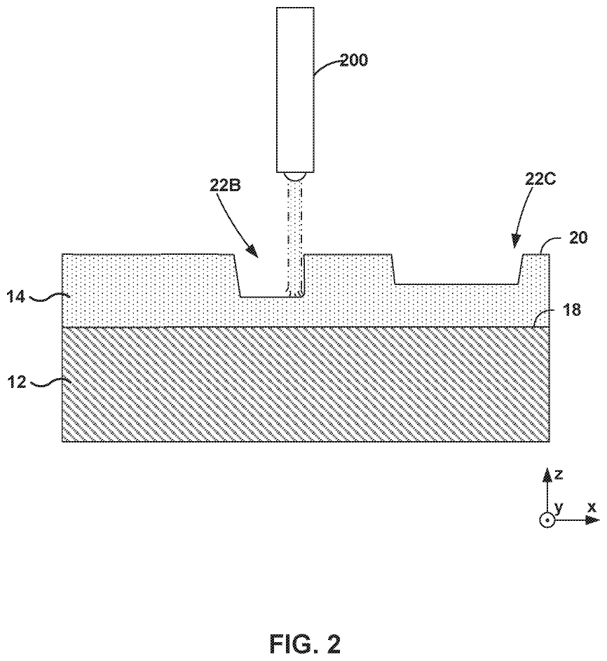

Cells 22 may be formed using any suitable technique. FIG. 2 is a schematic diagram illustrating article 10 including bond coat 14 on substrate 12, bond coat 14 having textured surface 20 including plurality of cells 22 formed by directing an ablation laser 200 at bond coat 14. Ablation laser 200 may be configured to remove portions of coating material from bond coat 14 (e.g., textured surface 20) via vaporization or melting the coating material to create cells 22. As ablation laser 200 is drawn over textured surface 20 in the x-y plane to progressively form cells 22, such as cell 22B. During the laser ablation process, portions of the removed coating material are expelled from textured surface 22. As the laser ablation process continues, subsequent cells 22 are formed on bond coat 14 to define textured surface 20.

The laser ablation process may be performed using any suitable ablation laser 200. In some examples, ablation laser 200 may be operated using a plurality of operating parameters including a beam frequency, a beam power, a defocus value, and a travel speed. The operating parameters of ablation laser 200 may be configured to form plurality of cells 22 that define the selected geometry, selected cell depth (e.g., D_{B} of cell 22B), and cell width (W_{C}). In some examples, the operating parameters of ablation laser 200 may be configured to have a beam frequency of less than about 200 Hz, a beam power of about 15 W to about 25 W, a defocus value of about −60 to about 50, and a cutting speed (e.g., the speed in which ablation laser 200 moves across in the x-y plane of substrate surface 22) of about 10 mm/s to about 200 mm/s.

In some examples, compared to mechanical machining, the laser ablation process may significantly reduce the chance of substrate 12 and/or bond coat 14 becoming cracked during the formation of plurality of cells 22 by reducing the mechanical force applied to substrate 12 and/or bond coat 14 during processing. Additionally, or alternatively, in some examples, due to the relatively small amount of material removed by ablation laser 200, the amount of heat applied and/or generated in substrate 12 and/or bond coat 14 may remain relatively low during the formation of plurality of cells 22 compared to other machining techniques. By reducing the heat applied and/or generated on substrate 12 and/or bond coat 14 during the laser ablation process, the chance of the material of substrate 12 (e.g. fibers) and/or bond coat 14 becoming oxidized prior to the application of coating 16 may be significantly reduced compared to other processing techniques.

In some examples, ablation laser 200 may be configured to form plurality of cells 22 on bond coat 14 even when outer surface 18 of substrate 12 is non-planar. For example, in some examples the underlying structure of substrate 12 (e.g., the reinforcement fibers) may cause textured surface 20 of bond coat 14 (e.g., prior to laser ablation) to be uneven or non-planar (e.g., mimicking the pattern of the reinforcement fibers). In such examples, ablation laser 200 may be configured to adjust the incident angle between the ablation beam and textured surface 20 to produce cells 22.

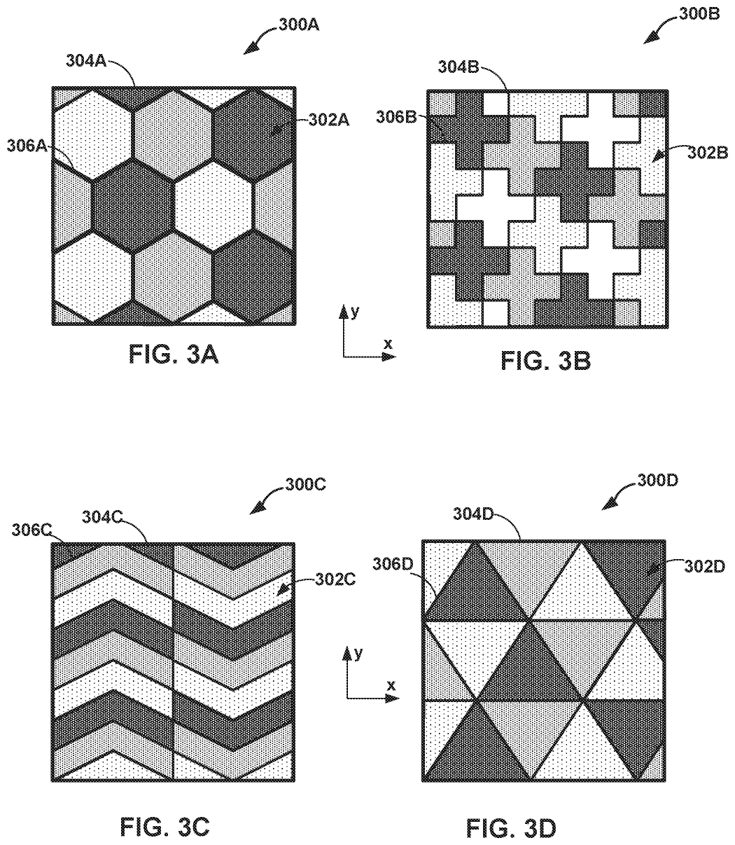

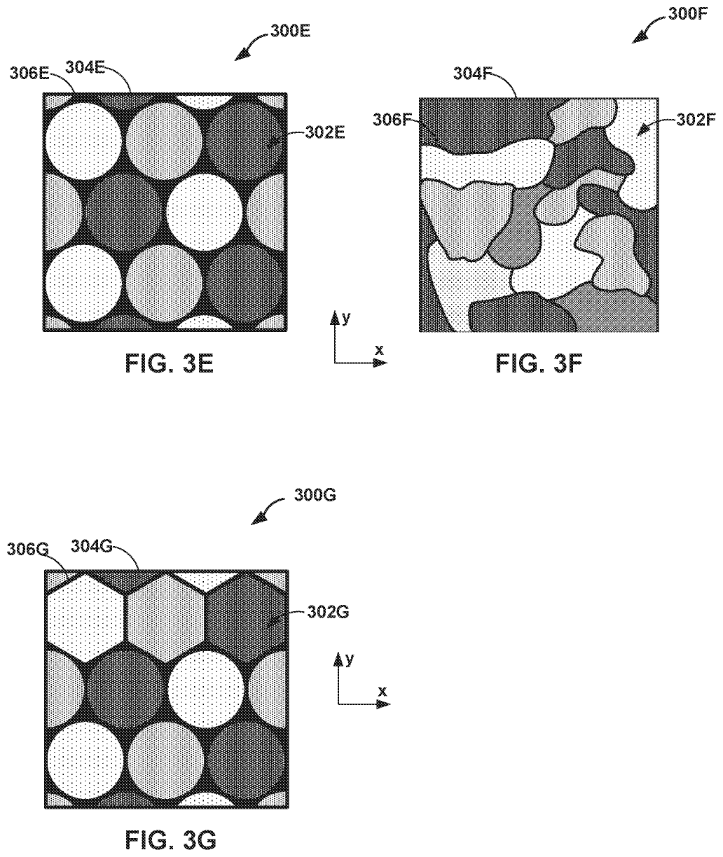

Each cell of cells 22 may be formed in bond coat 14 such that cells 22 progress across the substrate surface (e.g., progress in the x-y plane of FIG. 2) to form a macroscopic pattern. The macroscopic pattern defined by the plurality of cells 22 may be formed in any useful arrangement. For example, FIGS. 3A-3G show conceptual top-views of example bond coats 300A, 300B, 300C, 300D, 300E, 300F, and 300G (collectively, “bond coats 300”) that include plurality of cells 302A, 302B, 302C, 302D, 302E, 302F, and 302G (collectively, “cells 302”) arranged in a variety of macroscopic patterns to define textured surfaces 304A, 304B, 304C, 304D, 304E, 304F, and 304G (collectively, “textured surfaces 304”) of the respective bond coats 300 (e.g., cells 302 progressing in the x-y plane). As shown in FIGS. 3A-3G, in some examples, cells 302 may define a substantially rectilinear pattern (e.g., hexagons 302A of FIG. 3A, crosses 302B of FIG. 3B, chevrons 302C of FIG. 3C, or triangles 302D of FIG. 3D), a curved or curvilinear pattern (e.g., circles 302E of FIG. 3E), irregular patterns (e.g., irregular shapes 302F of FIG. 3F), a combination of patterns (e.g., hexagons and circles 302G of FIG. 3G), or the like.

Cells 302 may extend on textured surfaces 304 (e.g., progressing in the x-y plane) to reduce propagation of TGO between adjacent cells 302. For example, walls 306A, 306B, 306C, 306D, 306E, 306F, and 306G may inhibit or prevent TGO crystallization between adjacent cells 302 by at least disrupting crystallization of TGO in the x-y plane with walls 306 and the z plane with variation in depth of each adjacent cell of cells 302. Disrupting crystallization of TGO may reduce or prevent universal failure a coating system (e.g., coating system 13) and/or contain a failure to an individual cell or group of cells 302. Additionally, or alternatively, the use of different depths of adjacent cells 302 may reduce or prevent failure across a single plane (e.g., the x-y plane) of the coating system. In some examples, the pattern of cells 302 may extend on textured surfaces 304 to provide mechanical adhesion between bond coats 300 and any subsequent coating (e.g., coating 16 of FIG. 1). In some examples, cells 302 may serve to redistribute in-plane stresses, such as thermal stress or mechanical stress resulting from operations of an article including bond coats 300, including stress resulting from crystallization of TGO between bond coats 300 and a coating. For example, stress exerted on bond coats 300A in the y-axis direction of FIG. 3A, may be redistribute across the x-y plane as a result of the macroscopic pattern of plurality of cells 302A.

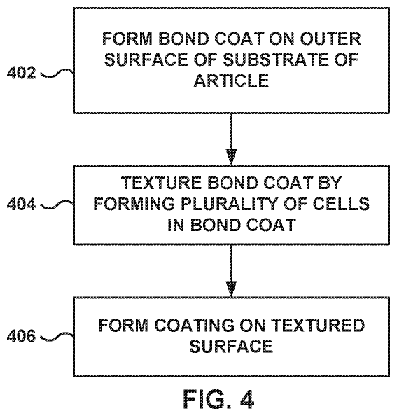

The articles, coatings, and/or and cells described herein may be formed using any suitable technique. For example, FIG. 4 is a flow diagram illustrating example technique for forming an article that includes a substrate; a bond coat formed on an outer surface of the substrate, the bond coat defining a textured surface having a plurality of cells, each cell having a geometry and a depth, where the depth of a respective cell is different than the depth of each adjacent cell; and a coating formed on the textured surface of the bond coat. While the technique of FIG. 4 is described with concurrent reference to the conceptual diagram of FIGS. 1-3G, in other examples, the technique of FIG. 4 may be used to form other articles, or article 10 may be formed using a technique different than that described in FIG. 4.

The technique of FIG. 4 includes forming bond coat 14 on outer surface 18 of substrate 12 of article 10 (402). As discussed above, forming bond coat 14 may include spraying (e.g., thermal spraying or plasma spraying), pressure vapor deposition (PVD), chemical vapor deposition (CVD), directed vapor deposition (DVD), dipping, electroplating, chemical vapor infiltration (CVI), or the like.

The technique illustrated in FIG. 4 also includes texturing bond coat 14 by forming plurality of cells 22 in bond coat 14 (404). As discussed above, each cell of cells 22 has a geometry and a depth, where the depth of a respective cell is different than the depth of each adjacent cell. Cells 22 may be formed using any suitable technique including, for example, laser ablation, focus ion beam ablation, plasma cutting, masking with plasma etching, micro-machining, or the like. In some examples, an ablation laser 200 may be directed at textured surface 20 of bond coat 14 to remove portions of the material of bond coat 14. In some examples, cells 22 may be formed to define a macrostructure pattern (as illustrated in FIGS. 3A-3G) progressing on textured surface 304 of bond coat 300.

In some examples, forming and texturing bond coat 14 may include 3D printing bond coat 14 or a portion of bond coat 14 onto outer surface 18 of substrate 12. For example, a first portion of bond coat 14 may be formed by spraying (e.g., thermal spraying or plasma spraying), pressure vapor deposition (PVD), chemical vapor deposition (CVD), directed vapor deposition (DVD), dipping, electroplating, chemical vapor infiltration (CVI), or the like, and a second portion of bond coat 14 may be formed by 3D printing the second portion onto an outer surface of the first portion. As one example, the first portion of bond coat 14 may include any portion of bond coat 14 below textured surface 20, e.g., such that cells 22 do not extend into the first portion of bond coat 14. The second portion of bond coat 14 may include cells 22 defining textured surface 20. The term 3D printing may include any suitable additive manufacturing process, such as, for example, stereolithography, digital light processing, fused deposition modeling, selective laser sintering, selective melting, electronic beam melting, laminated object manufacturing, binder jetting, or material jetting. In some example, 3D printing may be used as alternative to, or in addition to, subtractive manufacturing processes, e.g., laser ablation or micromachining. By using additive manufacturing processes, material loss during subsequent processing may be reduced.

The technique of FIG. 4 also includes forming a coating 16 on textured surface 20 (406). In some examples, coating 16 may include a plurality of layers, such as, for example, one or more EBC layers, one or more TBC layers, and/or one or more abradable layers. In some examples, the increase the interface area of the bonding surface established by the cell and anchor tooth structure may improve the adhesion between coating 14 and substrate 12.

Various examples have been described. These and other examples are within the scope of the following claims.

1. An article comprising:
a substrate defining an outer surface;
a bond coat on the outer surface of the substrate, wherein the bond coat defines a textured surface having a plurality of cells, each cell having a geometry in a major plane of the bond coat and a depth, wherein the depth of a respective cell is different than the depth of at least one adjacent cell; and
a coating on the textured surface of the bond coat.

2. The article of claim 1, wherein the bond coat defines a thickness, wherein each cell of the plurality of cells defines depth between about 25% to about 100% of the thickness of the bond coat.

3. The article of claim 1, wherein the geometry of each cell of the plurality of cells is substantially similar, wherein the geometry of each cell comprises at least one of a hexagon, a cross, a triangle, a chevron, or a circle.

4. The article of claim 1, wherein the article comprises a component of a high temperature mechanical system, wherein the geometry of a respective cell of the plurality of cells is based on a predicted stress at the respective cell during operation of the high temperature mechanical system.

5. The article of claim 1, wherein the geometry comprises a width of a respective cell of the plurality of cells, wherein the width is within a range between about 120 microns and about 200 microns.

6. The article of claim 1, wherein adjacent cells of the plurality of cells are separated by a distance of between about 20 and about 60 micrometers.

7. The article of claim 1, wherein walls defining each cell of the plurality of cells extend from a plane tangential to the outer surface of the substrate at an angle within a range from about 90-degrees to about 110-degrees.

8. The article of claim 1, wherein the coating comprises at least one of an environmental barrier coating, a thermal barrier coating, or an abradable coating.

9. The article of claim 1, wherein the substrate comprises a ceramic or a ceramic matrix composite.

10. A gas turbine engine component, comprising:
a ceramic composite matrix (CMC) substrate defining an outer surface;
a silicon-based bond coat on the outer surface of the substrate, wherein the silicon-based bond coat defines a textured surface having a plurality of cells, each cell having a geometry in a major plane of the silicon-based bond coat and a depth, wherein the depth of a respective cell is different than the depth of at least one adjacent cell; and
an environmental barrier coating (EBC) formed on the textured surface of the silicon-based bond coat.

11. A method for forming an article, the method comprising:
forming a bond coat on an outer surface of a substrate;
texturing the bond coat by forming a plurality of cells in the bond coat, each cell having a geometry in a plane of the bond coat and a depth, wherein the depth of a respective cell is different than the depth of at least one adjacent cell; and
forming a coating on the textured surface of the bond coat.

12. The method of claim 11, wherein the bond coat defines a thickness, wherein each cell of the plurality of cells defines depth between about 25% to about 100% of the thickness of the bond coat.

13. The method of claim 11, wherein the geometry of each cell of the plurality of cells is substantially similar, wherein the geometry of each cell comprises at least one of a hexagon, a cross, a triangle, a chevron, or a circle.

14. The method of claim 11, wherein the article comprises a component of a high temperature mechanical system, wherein texturing the bond coat comprises predicting a stress at respective cells during operation of the high temperature mechanical system and forming the respective cells based on the predicted stress at the respective cells.

15. The method of claim 11, wherein the geometry comprises a width of a respective cell of the plurality of cells, wherein the width is within a range between about 120 microns and about 200 microns.

16. The method of claim 11, wherein adjacent cells of the plurality of cells are separated by a distance of between about 20 and about 60 micrometers.

17. The method of claim 11, wherein walls defining each cell of the plurality of cells extend from a plane tangential to the outer surface of the substrate at an angle within a range from about 90-degrees to about 110-degrees.

18. The method of claim 11, wherein the coating comprises at least one of an environmental barrier coating, a thermal barrier coating, or an abradable coating.

19. The method of claim 11, wherein the substrate comprises a ceramic or a ceramic matrix composite.

20. The method of claim 11, wherein forming the plurality of cells comprises using an ablation laser to remove portions of the bond coat.
